(19) United States
(12) Patent Application Publication
(10) Pub. No.: US 2023/0230458 A1
(43) Pub. Date: Jul. 20, 2023

(54) AUTOMATED ELECTRONIC APPARATUS FOR CONSOLIDATED RESOURCE EVENT PROCESSING USING COMPUTER-READABLE INDICIA

(71) Applicant: BANK OF AMERICA CORPORATION, Charlotte, NC (US)

(72) Inventors: Paul Martin Mattison, Sherrills Ford, NC (US); Charles Hector Gruesbeck, II, Mint Hill, NC (US); Martha Sain McClellan, Lancaster, SC (US); David Smiddy, Chadds Ford, PA (US)

(73) Assignee: BANK OF AMERICA CORPORATION, Charlotte, NC (US)

(21) Appl. No.: 17/579,734

(22) Filed: Jan. 20, 2022

(51) Int. Cl. G07F 19/00

(52) U.S. Cl. CPC G07F 19/202; G07F 19/203; G07F 19/206; G07F 19/211; G07F 19/208

(57) ABSTRACT

Consolidated resource event processing at an automated electronic apparatus. A user having a resource depository that is associated with an entity other than the entity controlling the automated electronic apparatus is able to conduct certain resource events at the apparatus, e.g., inputting tangible resources at the automated electronic apparatus, initiating a resource event with a second user at the automated electronic apparatus using the tangible resources, and receiving tangible resources at the automated electronic apparatus. Computer-readable indicia is displayed on or proximate to the automated electronic apparatus which is captured and read by a mobile communication device, in possession of a user, to (i) identify the automated electronic apparatus, (ii) link the automated electronic apparatus to a resource depository held by the user at an entity different than the entity controlling the automated electronic apparatus and (iii) trigger the automated electronic apparatus to receive an input of tangible resources by the user.

### FIELD OF THE INVENTION

The present invention is generally directed resource event processing and, more specifically, providing for consolidated resource event processing at automated electronic apparatus using computer-readable indicia.

### BACKGROUND

In many instances automated electronic apparatus are configured, such that, certain resource event processing is only possible for users that have a resource depository associated with at the entity that controls the apparatus. For example, a user having a resource depository that is associated with a different entity (i.e., an entity other than the entity controlling the automated electronic apparatus) is not able to input tangible resources at the automated electronic apparatus and have the tangible resources applied as electronic resources to the resource depository associated with the different entity. Moreover, the user having a resource depository that is associated with an entity different than the entity controlling the automated electronic apparatus is not able to input tangible resources at the automated electronic apparatus and initiate a resource event with a second user at the automated electronic apparatus using the tangible resources.

Therefore, a need exists to develop systems, methods, computer program products and the like that consolidate resource event processing at automated electronic apparatus. In this regard, a need exists to provide systems, methods, computer program products and the like that allow for a user having a resource depository that is associated with an entity other than the entity controlling the automated electronic apparatus to conduct certain resource events at the apparatus, e.g., inputting tangible resources at the automated electronic apparatus and either communicating the resources to the resource depository associated with the different entity or initiating a resource event with a second user at the automated electronic apparatus using the tangible resources.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, computer program product and/or the like for consolidated resource event processing at automated electronic apparatus. Specifically, the present invention allows for a user having a resource depository that is associated with an entity other than the entity controlling the automated electronic apparatus to conduct certain resource events at the apparatus, e.g., inputting tangible resources at the automated electronic apparatus, communicating the resources to the resource depository associated with the different entity and/or initiating a resource event with a second user at the automated electronic apparatus using the tangible resources, and receiving tangible resources at the automated electronic apparatus.

Specifically, the present invention relies on a computer-readable indicia (e.g., a Quick Response (QR) code or the like) that is displayed on or proximate to the automated electronic apparatus. A mobile communication device, in possession of a user, captures and reads the computer-readable indicia, which serves to (i) identify the automated electronic apparatus, (ii) link the automated electronic apparatus to a resource depository held by the user at an entity different than the entity controlling the automated electronic apparatus and (iii) trigger the automated electronic apparatus to receive an input of tangible resources by the user. In response to receiving tangible resources of a specified volume from the user, the automated electronic apparatus is configured to communicate electronic resources of the specified volume to the linked resource depository.

In specific embodiments of the invention, the user may input a second user alias (e.g., email address, mobile telephone number or the like) either at the mobile communication device or the automated electronic apparatus and, in response to receiving the tangible resources of the specified volume from the user, the second user is notified that resources of the specified volume are available for receipt by the second user. In specific embodiments of the invention, the notification to the second user may include computer-readable indicia (e.g., QR code or the like) that identifies the second user and the specified volume. In such embodiments of the invention, the second user may present the computer-readable indicia at an entity-controlled automated electronic apparatus to receive an output of tangible resources of the specified volume.

Thus, the present invention provides a user the capability to input and/or output tangible resources at an automated electronic apparatus even though the resource depository(s) associated with the user are held by a different entity than the entity that controls the automated electronic apparatus.

A system for consolidated resource event processing defines first embodiments of the invention. The system includes an automated electronic apparatus controlled by a first entity and comprising a first computing platform having a first memory and one or more first computing processor device in communication with the first memory. Additionally, the system includes first computer-readable indicia displayed or displayable on or near the automated electronic apparatus. The first computer-readable indicia are configured to identify the automated electronic apparatus when captured and read by a computing platform. In addition, the system includes a mobile communication device in possession of the first user and comprising a second computing platform having a second memory, one or more second computing processor devices in communication with the second memory, and a first image capturing-device that is executable by at least one of the second processing devices and configured to capture the first computer-readable indicia. The second memory stores first instructions that are executable by at least one of the second processing devices and configured to, in response to the first image-capturing device capturing the first computer-readable indicia, (i) identify the automated electronic apparatus, (ii) link the automated electronic apparatus to a resource repository associated with the first user and controlled by a second entity different than the first entity, (iii) and trigger the automated electronic apparatus to receive tangible resources inputted by the first user.

In specific embodiments of the system, the first memory of the automated electronic apparatus stores second instructions that are executable by at least one of the first processing devices and configured to, in response to the automated electronic apparatus receiving tangible resources of a specified volume, communicate electronic resources of the specified volume to the resource repository associated with the first user and controlled by the second entity. In other specific embodiments of the system, the second instructions are further configured to authenticate the first user prior to the automated electronic apparatus being triggered to receive tangible resources inputted by the first user.

In additional specific embodiments of the system, at least one of the first or second instructions are further configured to receive, from the first user, an alias associated with a second user, and, in response to the automated electronic apparatus receiving tangible resources of the specified volume, initiate communication of resources of the specified volume to the second user. In such embodiments of the system, the first or second instructions may be further configured to initiate communication of resources of the specified volume to the second user by generating and communicating second computer-readable indicia to the second user. The second computer-readable indicia identifies the second user and the specified volume of resources. In such embodiments of the system, the automated electronic apparatus further comprises a second image-capturing device that is executable by at least one of the first processing devices and wherein the second instructions are further configured to (i) implement the second image-capturing device to capture the second computer-readable indicia, (ii) read the second computer-readable indicia to identify the second user and the specified volume, and (iii) in response to reading the second computer-readable indicia, trigger the automated electronic apparatus to dispense tangible resources in the specified volume. In specific embodiments of the system, the second instructions are further configured to authenticate the second user prior to triggering the automated electronic apparatus to dispense the tangible resources in the specified volume.

A computer-implemented method for performing consolidated resource events defines second embodiments of the invention. The method is executed by one or more processing devices. The method includes capturing, by a mobile communication device in possession of a first user, computer-readable indicia that is displayed on or proximate to an automated electronic apparatus and reading the captured computer-readable medium to (i) identify the automated electronic apparatus and (ii) link the automated electronic apparatus to a resource repository associated with the first user and controlled by a second entity different than a first entity controlling the automated electronic apparatus. In addition, the method includes, in response to reading the captured computer-readable indicia, triggering the automated electronic apparatus to receive tangible resources inputted by the first user.

In specific embodiments, the computer-implemented method further includes, in response to the automated electronic apparatus receiving tangible resources of a specified volume, communicating electronic resources of the specified volume to the resource repository associated with the first user and controlled by the second entity. In further specific embodiments, the computer-implemented method includes authenticating the first user at the automated electronic apparatus prior to the automated electronic apparatus being triggered to receive tangible resources inputted by the first user.

In other specific embodiments the computer-implemented method further includes receiving, from the first user, an alias associated with a second user, and in response to the automated electronic apparatus receiving tangible resources of the specified volume, initiating communication of resources of the specified volume to the second user. In such embodiments of the computer-implemented method, initiating communication of resources of the specified volume to the second user further includes generating and communicating second computer-readable indicia to the second user. The second computer-readable indicia identifies the second user and the specified volume of resources. In further such specific embodiments, the computer-implemented method includes capturing, at the automated electronic apparatus, the second computer-readable indicia presented by the second user, reading the second computer-readable indicia to identify the second user and the specified volume, and, in response to reading the second computer-readable indicia, triggering the automated electronic apparatus to dispense tangible resources in the specified volume. In specific such embodiments, the computer-implemented method further includes authenticating the second user at the automated electronic apparatus prior to triggering the automated electronic apparatus to dispense the tangible resources in the specified volume.

A computer program product including a non-transitory computer-readable medium defines third embodiments of the invention. The computer-readable medium includes a first set of codes for causing a mobile communication device in possession of a first user to capture computer-readable indicia that is displayed on or proximate to an automated electronic apparatus. The computer-readable medium additionally includes a second set of codes for causing the mobile communication device to read the captured computer-readable medium to identify the automated electronic apparatus and link the automated electronic apparatus to a resource repository associated with the first user and controlled by a second entity different than a first entity controlling the automated electronic apparatus. Additionally, the computer-readable medium includes a third set of codes for causing a computer to, in response to reading the captured computer-readable indicia, triggering the automated electronic apparatus to receive tangible resources inputted by the first user.

In specific embodiments of the computer program product, the computer-readable medium additionally includes a fourth set of codes for a set of codes for causing a computer to, in response to the automated electronic apparatus receiving tangible resources of a specified volume, communicate electronic resources of the specified volume to the resource repository associated with the first user and controlled by the second entity. In related embodiments of the computer program product, the computer-readable medium includes a fifth set of codes for causing a computer to authenticate the first user at the automated electronic apparatus prior to the automated electronic apparatus being triggered to receive tangible resources inputted by the first user.

In other related embodiments of the computer program product, the computer-readable medium includes a fifth set of codes for causing the mobile communication device or the automated electronic apparatus to receive, from the first user, an alias associated with a second user, and a sixth set of codes for causing a computer to, in response to the automated electronic apparatus receiving tangible resources of the specified volume, initiate communication of resources of the specified volume to the second user. In such embodiments of the computer program product, the sixth set of codes are further configured to generate and communicate second computer-readable indicia to the second user. The second computer-readable indicia identifies the second user and the specified volume of resources. In such embodiments of the computer program product, the computer-readable medium further includes a seventh set of codes for causing the automated electronic apparatus to capture the second computer-readable indicia presented by the second user, an eighth set of codes for causing the automated electronic apparatus to read the second computer-readable indicia to identify the second user and the specified volume, and a ninth set of codes for causing a computer to, in response to reading the second computer-readable indicia, trigger the automated electronic apparatus to dispense tangible resources in the specified volume.

Thus, according to embodiments of the invention, which will be discussed in greater detail below, the present invention provides for consolidated resource event processing at automated electronic apparatus. Specifically, the present invention allows for a user having a resource depository that is associated with an entity other than the entity controlling the automated electronic apparatus to conduct certain resource events at the apparatus, e.g., inputting tangible resources at the automated electronic apparatus, communicating the resources to the resource depository associated with the different entity and/or initiating a resource event with a second user at the automated electronic apparatus using the tangible resources, and receiving tangible resources at the automated electronic apparatus. In this regard, the present invention relies on a computer-readable indicia (e.g., a Quick Response (QR) code or the like) that is displayed on or proximate to the automated electronic apparatus. A mobile communication device, in possession of a user, captures and reads the computer-readable indicia, which serves to (i) identify the automated electronic apparatus, (ii) link the automated electronic apparatus to a resource depository held by the user at an entity different than the entity controlling the automated electronic apparatus and (iii) trigger the automated electronic apparatus to receive an input of tangible resources by the user.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic diagram of a system for consolidated resource event processing, in accordance with some embodiments of the present disclosure;

FIG. 2 is a block diagram of a mobile communication device configured to facilitate consolidated resource event processing, in accordance with some embodiments of the present disclosure;

FIG. 3 is a block diagram of an automated electronic apparatus configured for consolidated resource event processing, in accordance with some embodiments of the present disclosure; and

FIG. 4 is a flow diagram of a method for consolidated resource event processing, in accordance with some embodiments of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed for consolidated resource event processing at automated electronic apparatus, such as automated teller machine (ATM) or the like. Specifically, the present invention allows for a user having a resource depository that is associated with an entity other than the entity controlling the automated electronic apparatus to conduct certain resource events at the apparatus, e.g., inputting tangible resources at the automated electronic apparatus, communicating the resources to the resource depository associated with the different entity and/or initiating a resource event with a second user at the automated electronic apparatus using the tangible resources, and receiving tangible resources at the automated electronic apparatus. For example, the present invention allows for a user holding a financial account at a financial institution to conduct certain transactions at an ATM even though they ATM is controlled by another financial institution different than the financial institution at which the user's account(s) is held. For example, the present invention, allows for the user to deposit physical currency at the ATM and either have the currency be deposited in the user's financial account or sent to another user in peer-to-peer (P2P)-type transaction manner.

Specifically, the present invention relies on a computer-readable indicia (e.g., a Quick Response (QR) code or the like) that is displayed on or proximate to the automated electronic apparatus, e.g., a QR code displayed on a ATM (or displayable on the ATM's screen). A mobile communication device, in possession of a user, captures and reads the computer-readable indicia, which serves to (i) identify the automated electronic apparatus, (ii) link the automated electronic apparatus to a resource depository held by the user at an entity different than the entity controlling the automated electronic apparatus, and (iii) trigger the automated electronic apparatus to receive an input of tangible resources by the user. In response to receiving tangible resources of a specified volume from the user, the automated electronic apparatus is configured to communicate electronic resources of the specified volume to the linked resource depository. For example, a mobile communication device captures and reads a QR code or the like to (i) identify the ATM, (ii) link the ATM to the user's financial account held at financial institution which may be different than the financial institution controlling the ATM, and (iii) trigger the ATM to accept a physical currency input by the user.

In specific embodiments of the invention, the user may input a second user alias (e.g., email address, mobile telephone number or the like) either at the mobile communication device or the automated electronic apparatus and, in response to receiving the tangible resources of the specified volume from the user, the second user is notified that resources of the specified volume are available for receipt by the second user. For example, the user may input an alias at the mobile communication device or at the ATM and, in response to depositing the specified amount of physical currency, a communication is sent to the second user that notifies the second user of a payment by the user in the specified amount. In specific embodiments of the invention, the notification to the second user may include computer-readable indicia (e.g., QR code or the like) that identifies the second user and the specified volume. In such embodiments of the invention, the second user may present the computer-readable indicia at an entity-controlled automated electronic apparatus to receive an output of tangible resources of the specified volume. For example, the notification may includes a QR code that identifies the second user and the specified amount of currency and, in response to the second user presenting the QR code at an ATM (e.g., an ATM controlled by the same entity at which the physical currency was inputted), physical currency of the specified amount is dispensed from the ATM.

Thus, the present invention provides a user the capability to input and/or output tangible resources at an automated electronic apparatus even though the resource depository(s) associated with the user are held by a different entity than the entity that controls the automated electronic apparatus.

For more details regarding the concept of a consolidated resource event processing apparatus, such as a consolidated ATM, see U.S. patent application Ser. No. 17/533,130, filed Dec. 16, 2021, entitled “Systems and Methods Providing an Electronic Centralized Gateway Switch to a plurality of Network Devices”, assigned to the same assignee as the present invention and herein incorporated by reference as if setforth fully herein.

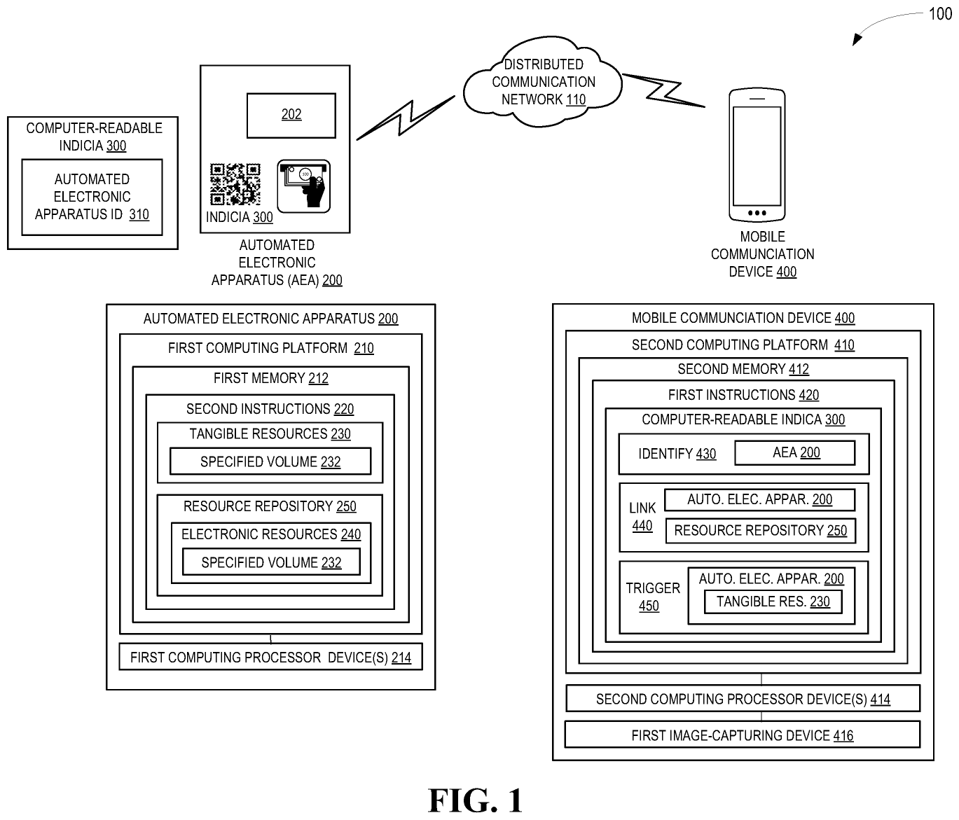

Turning now to the figures, FIG. 1 a schematic diagram is provided of a system 100 for consolidated resource event processing, in accordance with embodiments of the present invention. The system 100 is implemented within a distributed communication network 110, which may include the Internet, one or more intranets one or more cellular networks or the like. The system 100 includes automated electronic apparatus 200 which is configured to receive and output tangible resources. Automated electronic apparatus 200 may include a user-facing device and one or more backend devices in network communication with a user-facing device. Automated electronic apparatus 200 is controlled by a first entity; however, as will discussed herein, automated electronic apparatus is configured to perform resource events for users having resource repositories held at entities that are different than the entity controlling the automated electronic apparatus 200, such resource events including inputting tangible resources at the automated electronic apparatus and having the resources applied to the resource repository held at a different entity.

Automated electronic apparatus includes first computing platform 210 having first memory 212 and one or more first computing processor devices 214 in communication with first memory 212. First memory 212. First memory 212 stores second instructions 220 that are executable by at least one of the first computing processor devices 214. Second instructions 220 are configured to receive an input of tangible resources 230 of a specified volume 232 and, in response, communicate electronic resources 240 of the specified volume 232 to a resource repository 250 associated with a user.

System 100 additionally includes computer-readable indicia 300 that is displayed on or proximate to the automated electronic apparatus 200 and stores information that identifies the automated electronic apparatus 200. In specific embodiments of the system 100, the computer-readable indica 300 is permanently affixed to a facing of the automated electronic apparatus 200. In other specific embodiments of the system, the computer-readable indicia 300 is electronically displayed on a screen/display 202 of automated electronic apparatus 200. In such embodiments of the system 300, the computer-readable indicia may be dynamically generated and store additional information that is user-specific, resource event-specific, time dependent or the like.

System 100 additionally includes mobile communication device 400 that is in possession of a first user. Mobile communication device 400 includes second computing platform 410 having second memory 412 and one or more second computing processor devices 414. Additionally, mobile communication device 400 includes first image-capturing device 416 that is executable by at least one of the one or more second processing devices 414 and is configured to capture the first computer-readable indicia 300 displayed on or proximate to the automated electronic apparatus 200. Second memory 412 stores first instructions 420 that are executable by at least one of the one or more second processing devices 414 and configured to read the computer-readable indicia 300 to identify 430 the automated electronic apparatus 300 and, based on the identification 430 of the automated electronic apparatus 300, link 440 the automated electronic apparatus 300 to a resource repository 250 associated with the first user and controlled by a second entity (different than the first entity controlling the automated electronic apparatus 200).

Further, first instructions 420 are configured to trigger 450 the automated electronic apparatus 200 to receive tangible resources 230 inputted by the first user. The triggering 450 of the automated electronic apparatus 400 may occur via wireless/wired electronic communication conducted through the distributed communication network, while in other embodiments of the invention, the triggering 450 of the automated electronic apparatus may occur via direct short-range wireless communication between the mobile communication device 400 and the automated electronic apparatus 200. In specific embodiments of the system 100, triggering 450 results in displaying instructions on screen/display 202 of automated electronic apparatus 200 that notifies the first user that automated electronic apparatus 200 is configured to receive an input of tangible resources 250 and that the resources are to be stored in the resource repository 250 associated with the first user and controlled by a second entity.

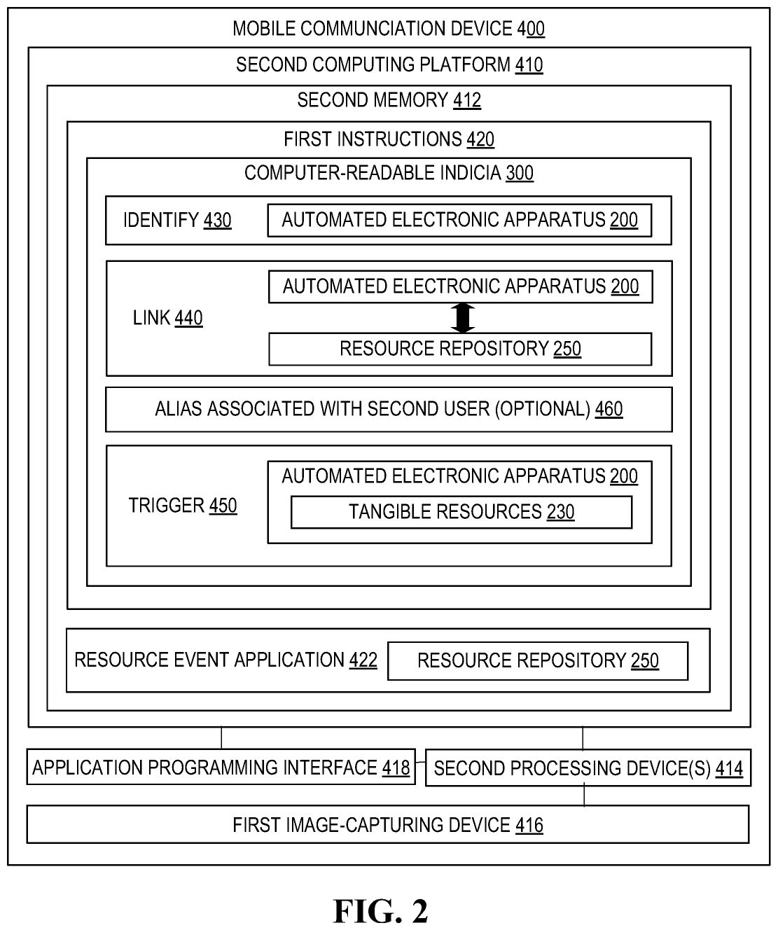

Referring to FIG. 2 a block diagram is depicted of the mobile communication device 400 configured to facilitate consolidated resource event processing at the automated electronic apparatus 200, in accordance with embodiments of the present invention. The mobile communication device 400 includes second computing platform 410 which is configured to execute instructions, such as algorithms, modules, routines, applications and the like. Second computing platform 410 includes second memory 412, which may comprise volatile and non-volatile memory, such as read-only and/or random-access memory (RAM and ROM), EPROM, EEPROM, flash cards, or any memory common to computing platforms). Moreover, second memory 412 may comprise cloud storage, such as provided by a cloud storage service and/or a cloud connection service.

Further, second computing platform 410 also includes at least one second processing device 414, which may be an application-specific integrated circuit (“ASIC”), or other chipset, logic circuit, or other data processing device. Second processing device(s) 414 may execute one or more application programming interface (APIs) 418 that interface with any resident programs, such as first instructions 420 or the like, stored in second memory 412 of second computing platform 410 and any external programs. Second processing devices(s) 414 may include various processing subsystems (not shown in FIG. 2) embodied in hardware, firmware, software, and combinations thereof, that enable the functionality of computing platform 300 and the operability of second computing platform 410 on the distributed computing network 110 (shown in FIG. 1). For example, processing subsystems allow for initiating and maintaining communications and exchanging data with other networked devices. For the disclosed aspects, processing subsystems of second processing device 414 may include any subsystem used in conjunction with first instructions 420 and related tools, routines, sub-routines, algorithms, sub-algorithms, sub-modules thereof.

Second computing platform 410 may additionally include a communications module (not shown in FIG. 2) embodied in hardware, firmware, software, and combinations thereof, that enables electronic communications between the computing platform 410 and other network devices, such as those shown in FIG. 1. Thus, communication module may include the requisite hardware, firmware, software and/or combinations thereof for establishing and maintaining a network communication connection with one or more distributed trust.

Additionally, mobile communication device 400 includes first image-capturing device 416 that is executable by at least one of the one or more second processing devices 414. According to embodiments of the present invention, first image-capturing device 416 is executed to capture the computer-readable indicia 300 displayed on or near the automated electronic apparatus 200. Further, in additional embodiments of the invention, second memory 412 stores resource event application 418 that is configured for conducting resource events and linked to resource repository 250 that is associated with the first user.

Second memory 412 of second computing platform 410 stores first instructions 420 that are configured to read the computer-readable indicia 300 to identify 430 the automated electronic apparatus 300 and, based on the identification 430 of the automated electronic apparatus 300, link 440 the automated electronic apparatus 300 to a resource repository 250 associated with the first user and controlled by a second entity (different than the first entity controlling the automated electronic apparatus 200). In specific embodiments of the invention, the reading of the computer-readable indicia is configured to launch resource event application 422, which include instructions for linking 440 the identified automated electronic apparatus 200 to the resource repository 250 associated with the application 422. Such linking 440 entails communicating, via the distributed communication network 110, with network devices that are in communication with the automated electronic apparatus 200 to notify the automated electronic apparatus 200 of the linkage.

In specific embodiments of the invention, in which the computer-readable indicia 300 is Quick Response (QR code) or the like, the automated electronic apparatus is an Automated Teller Machine (ATM), the resource repository is a financial account and the resource event application is a mobile banking application or specific peer-to-peer (P2P) payment application, first instructions 410 are configured to read the QR code to identity the ATM and, based on the identification of the ATM, link the ATM to the financial account. In specific embodiments of the invention, reading the QR code launches the mobile banking application including P2P payment functionality or standalone P2P payment application which is linked to the financial account. In such embodiments of the invention, the mobile banking application or the P2P payment application includes instructions for linking the ATM to the financial account. Such linkage includes communication with the ATM network to notify the ATM of the linkage to the financial account.

In alternate embodiments of the invention, first instructions 420 are configured to receive a user input of an alias 460 associated with a second user. The alias 460 is used such that the input of tangible resources 230 of a specified amount at the automated electronic apparatus 200, prompts notification to the second user of availability of resources of the specified amount. In other embodiments of the invention, the second instructions 220 of the automated electronic apparatus 200 may be configured to receive the user input of the alias 460 associated with the second user. In specific embodiments of the invention, the alias may be an email address or mobile telephone number and is used to facilitate payment to the second user of the specified amount in response to the first user inputting physical currency (i.e., tangible resources 250) into the ATM.

Further, first instructions 420 are configured to trigger 450 the automated electronic apparatus 200 to receive tangible resources 230 inputted by the first user. In specific embodiments of the invention, in which the automated electronic apparatus is an ATM and the tangible resources are physical currency, such a cash, first instructions 420 are configured to trigger the ATM to receive an input by the first user of physical currency. The triggering 450 of the automated electronic apparatus 400 may occur via wireless/wired electronic communication conducted through the distributed communication network, while in other embodiments of the invention, the triggering 450 of the automated electronic apparatus may occur via direct short-range wireless communication between the mobile communication device 400 and the automated electronic apparatus 200. In this regard, the resource event application 422 may be configured to communicate the trigger action to backend network devices that subsequently communicate the trigger to the automated electronic apparatus 200. In specific embodiments of the invention, in which the automated electronic apparatus 400 is an ATM and the resource event application 422 is a mobile banking application or standalone P2P payment application, the application may be configured to communicate the trigger to the ATM network, which notifies the specific ATM of the request to receive the physical currency inputted by the first user.

In specific embodiments of the system 100, triggering 450 results in displaying instructions on screen/display 202 of automated electronic apparatus 200 that notifies the first user that automated electronic apparatus 200 is configured to receive an input of tangible resources 250 and that the resources are to be stored in the resource repository 250 associated with the first user and controlled by a second entity. For example, in specific embodiments of the invention, in which the automated electronic apparatus is an ATM, triggering may result in displaying instructions on the display of the ATM that notifies the first user that the ATM is ready to receive an input of physical currency and that the specified amount of the currency is to be applied to the financial account of the user (which according to the invention is a financial account held by a different financial institution than the one that controls the ATM).

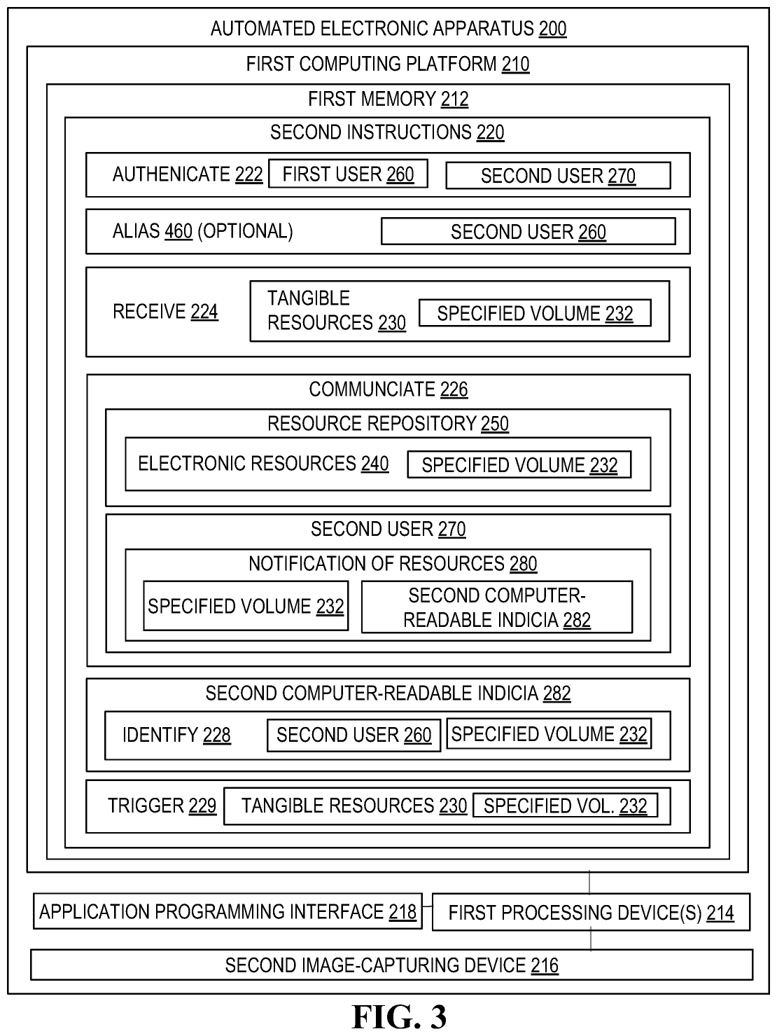

Referring to FIG. 3 a block diagram is depicted of the automated electronic apparatus 200 configured to provide consolidated resource event processing, in accordance with embodiments of the present invention. The automated electronic apparatus 200 includes first computing platform 210 which is configured to execute instructions, such as algorithms, modules, routines, applications and the like. First computing platform 210 includes first memory 212, which may comprise volatile and non-volatile memory, such as read-only and/or random-access memory (RAM and ROM), EPROM, EEPROM, flash cards, or any memory common to computing platforms). Moreover, first memory 212 may comprise cloud storage, such as provided by a cloud storage service and/or a cloud connection service.

Further, first computing platform 210 also includes at least one first processing device 214, which may be an application-specific integrated circuit (“ASIC”), or other chipset, logic circuit, or other data processing device. First processing device(s) 214 may execute one or more application programming interface (APIs) 218 that interface with any resident programs, such as second instructions 220 or the like, stored in first memory 212 of first computing platform 210 and any external programs. First processing devices(s) 214 may include various processing subsystems (not shown in FIG. 3) embodied in hardware, firmware, software, and combinations thereof, that enable the functionality of first computing platform 210 and the operability of first computing platform 210 on the distributed computing network 110 (shown in FIG. 1). For example, processing subsystems allow for initiating and maintaining communications and exchanging data with other networked devices. For the disclosed aspects, processing subsystems of first processing device 214 may include any subsystem used in conjunction with second instructions 220 and related tools, routines, sub-routines, algorithms, sub-algorithms, sub-modules thereof.

First computing platform 210 may additionally include a communications module (not shown in FIG. 3) embodied in hardware, firmware, software, and combinations thereof, that enables electronic communications between the computing platform 210 and other network devices, such as those shown in FIG. 1. Thus, communication module may include the requisite hardware, firmware, software and/or combinations thereof for establishing and maintaining a network communication connection with one or more distributed trust.

Additionally, automated electronic apparatus 200 includes second image-capturing device 216 that is executable by at least one of the one or more first processing devices 214. According to embodiments of the present invention, second image-capturing device 416 is executed to capture the second computer-readable indicia 282 displayed on the notification of resources 280 provided to the second user 270 and discussed, infra.

First memory 212 of first computing platform 210 stores second instructions 220 that are configured to receive the trigger for receiving tangible resources 230 inputted by the first user 260. In specific embodiments of the invention, prior to configuring the automated electronic apparatus 200 for receipt of the of the tangible resources 230, second instructions 220 are configured to authenticate 220 the first user. In those embodiments in which the automated electronic apparatus 200 is an ATM or the like, authentication may be provided by inserting a payment/debit card and inputting a predetermined personal identification number (PIN) or the like.

Once triggered, second instructions 220 are configured to prompt the automated electronic apparatus 200 to receive 224 tangible resources 230 of a specified volume 232 as inputted by the first user 260. In specific embodiments of the invention, second instructions 220 are configured to prompt the ATM to receive 224 physical currency as inputted by the first user 260.

In alternate embodiments of the invention, second instructions 420 are configured to receive a user input of an alias 460 associated with the second user 270. The alias 460 is used such that the input of tangible resources 230 of a specified volume 232 at the automated electronic apparatus 200, prompts notification to the second user 270 of availability of resources of the specified amount, as discussed infra. As previously discussed in relation to FIG. 2, in other embodiments of the invention, first instructions 420 of the mobile communication device 400 may be configured to receive the user input of the alias 460 associated with the second user 270. In specific embodiments of the invention, the alias may be an email address or mobile telephone number and is used to facilitate payment to the second user 270 of the specified amount in response to the first user inputting physical currency (i.e., tangible resources 250) into the ATM.

In response to receiving 224 the tangible resources 230 of the specified volume 232, second instructions are further configured to communicate at least one of (i) electronic resources 240 of specified volume 232 to the linked resource repository 250 associated with the first user 260 and (ii) a notification of resources 280 to the second user 270 that notifies the second user of the availability of resources of the specified volume 232. In specific embodiments of the invention, second instructions are configured to communicate at least one of (i) electronic currency of the specified amount to the linked financial account associated with the first user, and (ii) a notification of payment to the second user 270 that notifies the second user of the availability of a payment of the specified amount.

In additional embodiments of the invention, the notification may include second computer-readable indicia 282 that identifies the second user 270 and the specified volume 232 of resources. The second computer-readable indicia 282 may come with instructions in the notification 280 instructing the second user 270 with the option for receiving tangible resources by presenting the second computer-readable indicia 282 at an automated electronic apparatus 200 (one of ordinary skill in the art will appreciate that the automated electronic apparatus 200 at which the second computer-re4adable indicia 282 is presented need not be the same automated electronic apparatus 200 at which the tangible resources 240 were inputted). In specific embodiments of the invention, the second computer-readable indicia 282 may be a QR code that identifies the second user and the specified amount of payment.

In such embodiments of the invention, second image-capturing device 216 of automated electronic apparatus 200 is configured to capture second computer-readable indicia 282 when presented by the second user 270. Second instructions 220 are configured to read the second computer-readable indicia 282 to identify 228 the second user 260 and the specified volume 232 and, in response trigger 229 the automated electronic apparatus 200 to dispense tangible resources 230 of the specified volume 232 to the second user 270. In specific embodiments of the invention, second instructions 220 are configured to read the QR code to identify the second user 260 and the specified amount of payment and trigger the ATM to dispense physical currency of the specified amount to the second user 270.

In specific embodiments of the invention, prior to triggering the automated electronic apparatus 200 to dispense the tangible resources 230 of the specified volume 230, second instructions 220 are configured to authenticate 220 the second user 260. In those embodiments in which the automated electronic apparatus 200 is an ATM or the like, authentication may be provided by inserting a payment/debit card and inputting a predetermined personal identification number (PIN) or the like.

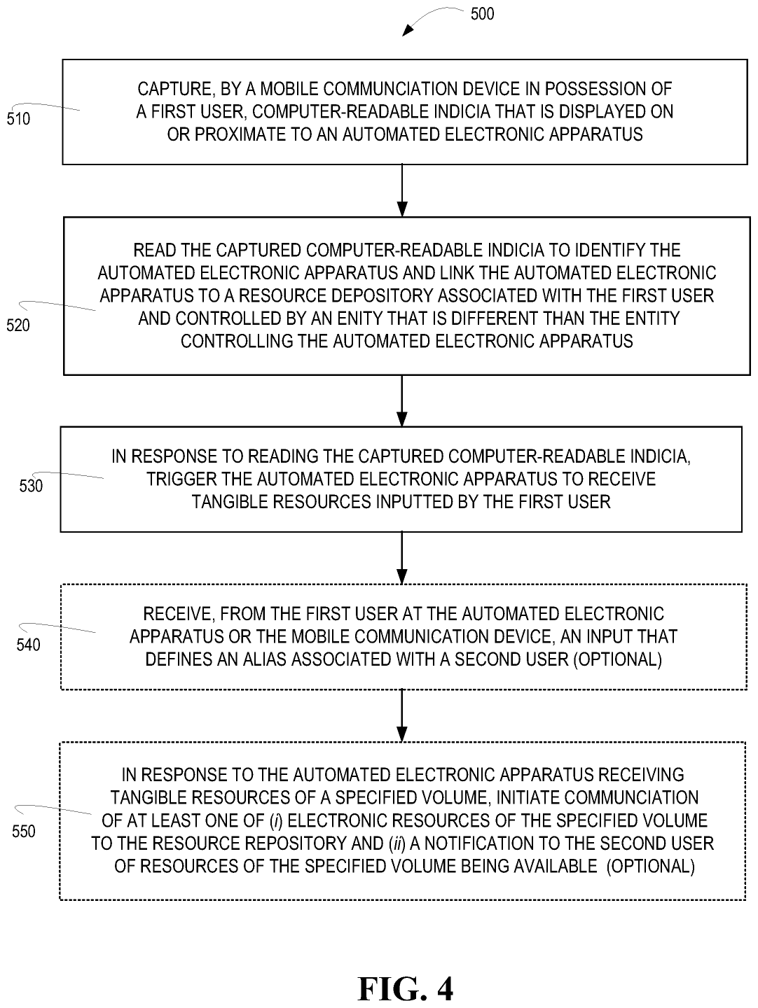

Referring to FIG. 4 a flow diagram is presented of a computer-implemented method 500 for providing consolidated resource event processing, in accordance with embodiments of the present invention. The computer-implemented method is executable by one or more processing devices which may be disposed in one or more computing platforms. At Event 510, a mobile communication in possession of a user (i.e., first user) captures computer-readable indicia displayed on or proximate to an automated electronic apparatus that is in control of a first entity. In specific embodiments of the method, the computer-readable indicia is a QR code or the like and the automated electronic apparatus is an automated teller machine (ATM) in control of a first financial institution.

At 520, the captured computer-readable indicia is read to (i) identify the automated electronic apparatus and (ii) in response to identification of the automated electronic apparatus, link the automated electronic apparatus to a resource repository associated with the user and controlled by a different entity (i.e., an entity other than the entity controlling the automated electronic apparatus). In specific embodiments of the method, the captured QR code or the like is read to identity the ATM or the like and the identified ATM is linked to a financial account held by the user at a financial institution that is different than the financial institution in control of the ATM. In such embodiments of the method, capturing the QR code may trigger launching of a mobile banking application including P2P payment functionality or a standalone P2P payment application, which is associated with the financial account (i.e., the payment account), such that the identified ATM is linked to the financial account associated with the mobile banking application or the P2P payment application.

In response to reading the captured computer-readable indicia and linking the automated electronic apparatus to the resource repository, at Event 530, the automated electronic apparatus is triggered to receive user inputs of tangible resources. In specific embodiments of the method, in response to reading the QR code or the like and linking the identified ATM to the financial account of the user, the ATM is triggered to receive physical currency from the user.

At optional Event 540, the mobile communication device or the automated electronic apparatus receives a user input that defines an alias associated with a second user. In specific embodiments of the method, the mobile communication or the ATM or the like, receives a user input that defines an alias, such as a n email address, mobile telephone number or the like associated with a second user.

In response to the automated electronic apparatus receiving tangible resources of a specified volume, at optional Event 550, communication is initiated of at least one of (i) electronic resources of the specified volume to the resource repository and (ii) a notification to the second user of resource of the specified volume being available. In specific embodiments of the method, in response to the ATM receiving physical currency of a specified amount, communication is initiated of at least one of (i) electronic currency of the specified amount to the financial account of the first user and (ii) an email or text message notification to the second user notifying the second user of availability of a payment from the first user of the specified amount. In this regard, the physical currency that is inputted by the first user may be deposited in their account (held by a different financial institution than the financial institution that controls the ATM) and/or used as a P2P payment transaction between the first user and the second user.

Thus, present embodiments of the invention provide for consolidated resource event processing at automated electronic apparatus. Specifically, the present invention allows for a user having a resource depository that is associated with an entity other than the entity controlling the automated electronic apparatus to conduct certain resource events at the apparatus, e.g., inputting tangible resources at the automated electronic apparatus, communicating the resources to the resource depository associated with the different entity and/or initiating a resource event with a second user at the automated electronic apparatus using the tangible resources, and receiving tangible resources at the automated electronic apparatus. In this regard, the present invention relies on a computer-readable indicia (e.g., a Quick Response (QR) code or the like) that is displayed on or proximate to the automated electronic apparatus. A mobile communication device, in possession of a user, captures and reads the computer-readable indicia, which serves to (i) identify the automated electronic apparatus, (ii) link the automated electronic apparatus to a resource depository held by the user at an entity different than the entity controlling the automated electronic apparatus and (iii) trigger the automated electronic apparatus to receive an input of tangible resources by the user.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for consolidated resource event processing, the system comprising:
an automated electronic apparatus controlled by a first entity and comprising a first computing platform having a first memory and one or more first computing processor device in communication with the first memory;
first computer-readable indicia displayed or displayable on or near the automated electronic apparatus, wherein the first computer-readable indicia are configured to identify the automated electronic apparatus when captured and read by a computing platform; and
a mobile communication device in possession of the first user and comprising a second computing platform having a second memory, one or more second computing processor devices in communication with the second memory, and a first image capturing-device executable by at least one of the second processing devices and configured to capture the first computer-readable indicia, wherein the second memory stores first instructions that are executable by at least one of the second processing devices and configured to, in response to the first image-capturing device capturing the first computer-readable indicia:
identify the automated electronic apparatus;
link the automated electronic apparatus to a resource repository associated with the first user and controlled by a second entity different than the first entity; and
trigger the automated electronic apparatus to receive tangible resources inputted by the first user.

2. The system of claim 1, wherein the first memory of the automated electronic apparatus stores second instructions that are executable by at least one of the first processing devices and configured to:
in response to the automated electronic apparatus receiving tangible resources of a specified volume, communicate electronic resources of the specified volume to the resource repository associated with the first user and controlled by the second entity.

3. The system of claim 2, wherein the second instructions are further configured to:
authenticate the first user prior to the automated electronic apparatus being triggered to receive tangible resources inputted by the first user.

4. The system of claim 2, wherein the first or second instructions are further configured to:
receive, from the first user, an alias associated with a second user; and
in response to the automated electronic apparatus receiving tangible resources of the specified volume, initiate communication of resources of the specified volume to the second user.

5. The system of claim 4, wherein the first or second instructions are further configured to:
initiate communication of resources of the specified volume to the second user by generating and communicating second computer-readable indicia to the second user, wherein the second computer-readable indicia identifies the second user and the specified volume of resources.

6. The system of claim 5, wherein the automated electronic apparatus further comprises a second image-capturing device that is executable by at least one of the first processing devices and wherein the second instructions are further configured to:
implement the second image-capturing device to capture the second computer-readable indicia,
read the second computer-readable indicia to identify the second user and the specified volume, and
in response to reading the second computer-readable indicia, trigger the automated electronic apparatus to dispense tangible resources in the specified volume.

7. The system of claim 6, wherein the second instructions are further configured to authenticate the second user prior to triggering the automated electronic apparatus to dispense the tangible resources in the specified volume.

8. A computer-implemented method for performing consolidated resource events, the method is executed by one or more processing devices and comprises:
capturing, by a mobile communication device in possession of a first user, computer-readable indicia that is displayed on or proximate to an automated electronic apparatus;
reading the captured computer-readable medium to identify the automated electronic apparatus and link the automated electronic apparatus to a resource repository associated with the first user and controlled by a second entity different than a first entity controlling the automated electronic apparatus; and
in response to reading the captured computer-readable indicia, triggering the automated electronic apparatus to receive tangible resources inputted by the first user.

9. The computer-implemented method of claim 8, further comprising:
in response to the automated electronic apparatus receiving tangible resources of a specified volume, communicating electronic resources of the specified volume to the resource repository associated with the first user and controlled by the second entity.

10. The computer-implemented method of claim 9, further comprising:
authenticating the first user at the automated electronic apparatus prior to the automated electronic apparatus being triggered to receive tangible resources inputted by the first user.

11. The computer-implemented method of claim 9, further comprising:
receiving, from the first user, an alias associated with a second user; and
in response to the automated electronic apparatus receiving tangible resources of the specified volume, initiating communication of resources of the specified volume to the second user.

12. The computer-implemented method of claim 11, wherein initiating communication of resources of the specified volume to the second user further comprises:
generating and communicating second computer-readable indicia to the second user, wherein the second computer-readable indicia identifies the second user and the specified volume of resources.

13. The computer-implemented method of claim 12, further comprising:
capturing, at the automated electronic apparatus, the second computer-readable indicia presented by the second user;
reading the second computer-readable indicia to identify the second user and the specified volume; and
in response to reading the second computer-readable indicia, triggering the automated electronic apparatus to dispense tangible resources in the specified volume.

14. The computer-implemented method of claim 13, further comprising:
authenticating the second user at the automated electronic apparatus prior to triggering the automated electronic apparatus to dispense the tangible resources in the specified volume.

15. A computer program product comprising:
a non-transitory computer-readable medium comprising:
a first set of codes for causing a mobile communication device in possession of a first user to capture computer-readable indicia that is displayed on or proximate to an automated electronic apparatus;
a second set of codes for causing the mobile communication device to read the captured computer-readable medium to identify the automated electronic apparatus and link the automated electronic apparatus to a resource repository associated with the first user and controlled by a second entity different than a first entity controlling the automated electronic apparatus; and
a third set of codes for causing a computer to, in response to reading the captured computer-readable indicia, triggering the automated electronic apparatus to receive tangible resources inputted by the first user.

16. The computer program product of claim 15, further comprising a fourth set of codes for causing a computer to, in response to the automated electronic apparatus receiving tangible resources of a specified volume, communicate electronic resources of the specified volume to the resource repository associated with the first user and controlled by the second entity.

17. The computer program product of claim 16, further comprising a fifth set of codes for causing a computer to authenticate the first user at the automated electronic apparatus prior to the automated electronic apparatus being triggered to receive tangible resources inputted by the first user.

18. The computer program product claim 16, further comprising:
a fifth set of codes for causing the mobile communication device or the automated electronic apparatus to receive, from the first user, an alias associated with a second user; and
a sixth set of codes for causing a computer to, in response to the automated electronic apparatus receiving tangible resources of the specified volume, initiate communication of resources of the specified volume to the second user.

19. The computer program product of claim 18, wherein the sixth set of codes are further configured to generate and communicate second computer-readable indicia to the second user, wherein the second computer-readable indicia identifies the second user and the specified volume of resources.

20. The computer program product of claim 19, further comprising:
a seventh set of codes for causing the automated electronic apparatus to capture the second computer-readable indicia presented by the second user;
an eighth set of codes for causing the automated electronic apparatus to read the second computer-readable indicia to identify the second user and the specified volume; and
a ninth set of codes for causing a computer to, in response to reading the second computer-readable indicia, trigger the automated electronic apparatus to dispense tangible resources in the specified volume.
